(19) United States
(12) Patent Application Publication
(10) Pub. No.: US 2009/0207295 A1
(43) Pub. Date: Aug. 20, 2009

(54) IMAGING DEVICE AND DRIVING METHOD THEREOF

(75) Inventors: Hiromasa Funakoshi, Hyogo (JP); Takeo Minami, Osaka (JP); Mitsuhiro Sasaki, Osaka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/366,952

(22) Filed: Feb. 6, 2009

(30) Foreign Application Priority Data
Feb. 8, 2008 (JP) 2008-028823

(51) Int. Cl. H04N 5/335

(52) U.S. Cl. 348/311

(57) ABSTRACT

An imaging device includes a vertical transfer unit to sequentially transfer the charges generated by photoelectric conversion elements in a vertical direction with the transfer registers, during a vertical transfer period, a horizontal transfer unit to horizontally transfer the charges transferred by the vertical transfer unit, during a horizontal transfer period, and a controller to control the vertical transfer unit and the horizontal transfer unit. The controller controls the vertical transfer unit such that the number of transfer registers used to store the charges during the horizontal transfer period is larger than the number of transfer registers used to store the charges during the vertical transfer period.

### BACKGROUND OF THE INVENTION

1. Field of the Invention

The present invention relates to an imaging device including a photoelectric conversion element such as a CCD, particularly to the imaging device which vertically and horizontally transfers sequentially charges generated by the photoelectric conversion element to output the charges, and the driving method thereof.

2. Related Art

A CCD image sensor is well known as an imaging element used in a digital still camera, and the like. The CCD image sensor includes photodiodes arrayed two-dimensionally. The photodiode is a photoelectric conversion element for generating charges according to amount of received light. The CCD image sensor further includes vertical transfer registers each of which vertically transfers the charges generated by each photodiodes and a horizontal transfer register each of which horizontally transfers the charges generated by each photodiode. The charges generated by each photodiode are vertically transferred in each column by the vertical transfer register. Then, the charges from the vertical transfer register of each column are sequentially transferred in the horizontal direction by the horizontal transfer register, thereby supplying image data from the CCD image sensor (for example, see JP-A-03-016480).

In the CCD image sensor having the above-described configuration, when imaging a high-brightness subject, it may happen that unnecessary charges are mixed into the charges which are of the pixel data while the charges are transferred by the transfer register. The mixing of the unnecessary charges deteriorates quality of an image which is generated by the image data supplied from the CCD image sensor. Conventionally the prevention of the mixing of the unnecessary charges into the charges of the pixel data is achieved by various techniques.

### SUMMARY OF THE INVENTION

The present invention is directed to solve the problems described above, and an object thereof is to provide an imaging device capable of reducing the mixing of unnecessary charges into an original pixel data to provide a good quality image.

In the first aspect of the invention, an imaging device is provided. The imaging device includes: photoelectric conversion elements operable to generate charges as pixel data by photoelectric conversion; a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period; a horizontal transfer unit operable to horizontally transfer the charges transferred by the vertical transfer unit during a horizontal transfer period; and a controller operable to control the vertical transfer unit and the horizontal transfer unit. The controller controls the vertical transfer unit such that the number of transfer registers used to store the charges during the horizontal transfer period is larger than the number of transfer registers used to store the charges during the vertical transfer period.

In the second aspect of the invention, a driving method of an imaging device is provided. The imaging device includes photoelectric conversion elements operable to generate charges as pixel data by photoelectric conversion, a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period, and a horizontal transfer unit operable to horizontally transfer the charges transferred by the vertical transfer unit during a horizontal transfer period. The driving method includes controlling the number of transfer registers such that the number of transfer registers used to store the charges during the horizontal transfer period is larger than the number of transfer registers used to store the charges during the vertical transfer period.

According to configurations of the first and second aspects, the amount of charges overflowing from the vertical transfer register to the horizontal transfer register is restrained, so that the mixing of the unnecessary charges into the original pixel data can be decreased to reduce the defect of the image in imaging the high-brightness subject.

In the third aspect of the invention, an imaging device is provided. The imaging device includes: photoelectric conversion elements formed on a substrate to generate charges as pixel data by photoelectric conversion; a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period; a horizontal transfer unit operable to horizontally transfer the charges transferred by the vertical transfer unit during a horizontal transfer period; and an electronic shutter controller operable to control an electronic shutter function of discharging the charges generated by the photoelectric conversion element to the substrate side. The electronic shutter controller can control applying a first voltage which is applied for performing the electronic shutter function and a second voltage which is lower than the first voltage, to the substrate, and applies the second voltage a predetermined times per horizontal transfer period during an exposure period of the photoelectric conversion element. The predetermined times is once or twice.

In the fourth aspect of the invention, a driving method of an imaging device is provided. The imaging device includes photoelectric conversion elements formed on a substrate to generate charges as pixel data by photoelectric conversion, a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period, a horizontal transfer unit operable to horizontally transfer the charges transferred by the vertical transfer unit during a horizontal transfer period, and an electronic shutter controller operable to control an electronic shutter function of discharging the charges generated by the photoelectric conversion element to the substrate side. The driving method includes applying a first voltage to the substrate when performing the electronic shutter function, and applying a second voltage to the substrate which is lower than the first voltage, a predetermined times per horizontal transfer period during an exposure period of the photoelectric conversion element.

In the configurations according to the third and fourth aspects, the capacity of the photoelectric conversion element is reduced during the exposure period, and thus the amount of charges overflowing from the photoelectric conversion element to the transfer register is reduced. Accordingly the blooming can be restrained to reduce the defect of the image in imaging the high-brightness subject.

According to the invention, the imaging device which can reduce the mixing of the unnecessary charges into the original pixel data and produce the good quality image can be provided.

### BRIEF DESCRIPTION OF DRAWINGS

FIG. 1 shows a configuration of a CCD image sensor according to a first embodiment of the present invention.

FIG. 2A is an explanatory view of gates of horizontal transfer CCDs, FIG. 2B shows a gate voltage waveform ΦH1, and FIG. 2C shows a gate voltage waveform ΦH2.

FIGS. 3A to 3F are explanatory views of a charge transfer operation performed by a vertical transfer CCD.

FIG. 4A is a timing chart showing transferring timing of a horizontal synchronization signal (HD), FIG. 4B is a timing chart showing a driving state of the horizontal transfer CCD, FIG. 4C is a view showing a change in amount of unnecessary charge overflowing from a vertical transfer register to a horizontal transfer register, and FIG. 4D is a view explaining a state in which the charges overflow in the vertical transfer register.

FIG. 5 shows an example of an image generated in imaging a high-brightness subject.

FIGS. 6A to 6D are explanatory views showing a state in which the charges are stored in the vertical transfer CCD according to the first embodiment of the present invention.

FIG. 7 shows a configuration of a CCD image sensor according to a second embodiment of the present invention.

FIG. 8 is a sectional view showing a potential near a boundary between a photodiode and a substrate.

FIGS. 9A to 9D are timing charts showing various control signals according to the second embodiment of the present invention.

FIGS. 10A to 10D are other timing charts showing various control signals according to the second embodiment of the present invention.

### DETAIL DESCRIPTION OF THE PREFERRED EMBODIMENT

Exemplary embodiments of the present invention will be described below with reference to the accompanying drawings.

### First Embodiment

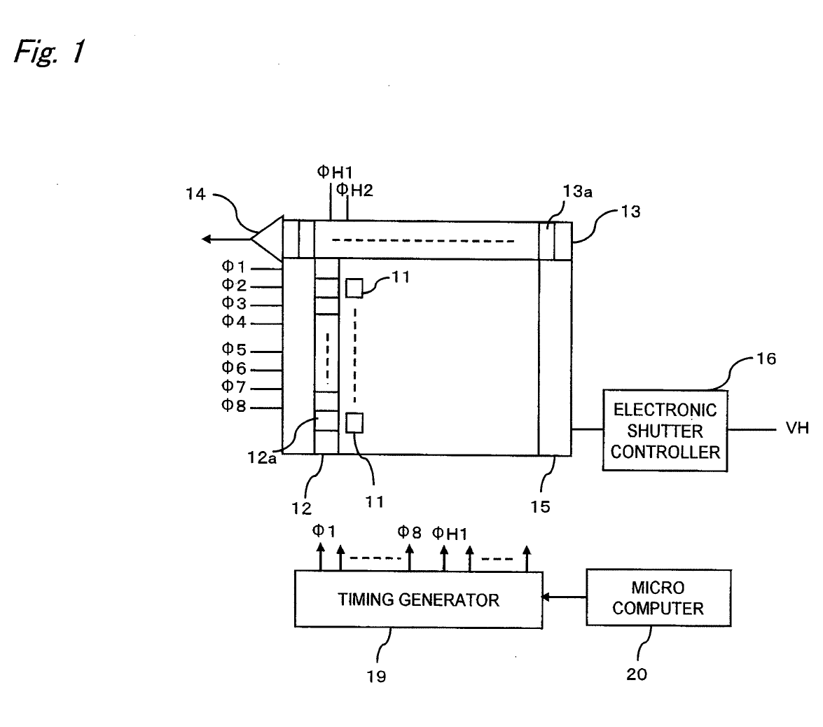

FIG. 1 shows a configuration of a CCD image sensor according to a first embodiment of the present invention. The CCD image sensor includes two-dimensionally arrayed photodiodes 11, vertical transfer CCDs 12 each of which is disposed in parallel with each line of the photodiodes 11, horizontal transfer CCDs 13 each of which is connected to an end of the vertical transfer CCD 12, an output amplifier 14 which is connected to the horizontal transfer CCD 13, and an OB unit 15 which imparts a reference black level. The CCD image sensor also includes an electronic shutter controller 16, thereby enabling electronic shutter control.

Various control signals (control voltages) Φ1 to Φ8 and ΦH1, . . . are fed into the CCD image sensor. These control signals (control voltages) Φ1, . . . are generated by a timing generator 19 under control of a microcomputer 20. The microcomputer 20 is control means for controlling the entire operation of a device (for example, digital still camera) which includes the CCD image sensor. The microcomputer 20 provides the timing generator 19 with control information based on various settings and user's operation.

The photodiode 11 generates charges according to a quantity of received light by the photoelectric conversion. Pixel data is expressed by the charges generated by the photoelectric conversion of the photodiode 11.

The charges (pixel data) generated by the photodiode 11 are read out to the vertical transfer CCD 12. The vertical transfer CCD 12 includes a plurality of vertical transfer registers 12a disposed vertically. Voltages Φ1 to Φ8 can be applied to each gate of each vertical transfer register 12a through metal interconnections, respectively. Application of voltage Φ1, . . . , Φ8 to the gates can change potential at the vertical transfer register. The pixel data is moved sequentially in the vertical transfer register by controlling a timing of voltage application to the gate (that is, a phase of the gate voltage). “The pixel data is moved sequentially” means that the charges are transferred by applying to the vertical transfer registers the voltages being changed as motion of a measuring worm. In this manner, the pixel data generated by the photodiodes 11 can be transferred to the horizontal transfer CCD 13. The transfer operation of the vertical transfer CCD 12 is described later.

In the transfer by the vertical transfer CCD 12, all pixel readout drive and thinning-out readout drive can be selectively adopted by controlling the voltages Φ1 to Φ8 applied to the vertical transfer CCD 12. In the case of the thin-out readout drive, some pixels are not read out, and gates correspond to the pixels which are not read out are turned off.

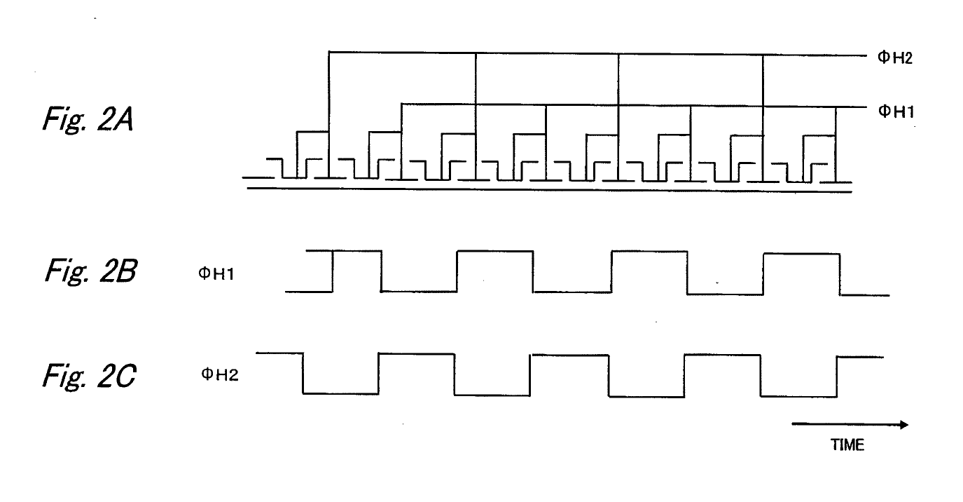

The horizontal transfer CCD 13 includes a plurality of horizontal transfer registers 13a arrayed horizontally, and outputs sequentially the pixel data transferred from the vertical transfer CCD 12 of each column to the output amplifier 14. The output amplifier 14 converts pixel data transferred from the horizontal transfer CCD 13, from data as charge amount, to data as voltage value. The OB unit 15 defines an optical black level. Specifically, the black level is defined by setting a level of a signal from the OB unit 15 at a zero level. FIG. 2A shows an example of a gate array of the horizontal transfer CCD 13. Voltages Φ1 or Φ2 are applied to gates of each horizontal transfer register 13a. In this example, transfer of the charges in the horizontal transfer CCD 13 is controlled by application of voltage in two-phase (two-phase drive). FIGS. 2B and 2c show examples of waveforms of voltages ΦH1 and ΦH2, respectively.

The electronic shutter controller 16 is means for controlling an electronic shutter function. A potential difference between the photodiode 11 and a substrate of the CCD image sensor can be changed by the electronic shutter controller 16 applying a voltage to the substrate of the CCD image sensor. Making the potential at the substrate higher than the potential at the photodiode 11 allows the charges stored in the photodiode 11 to be discharged on the substrate side. The function of discharging the charges stored in the photodiode 11 is referred to as “electronic shutter”.

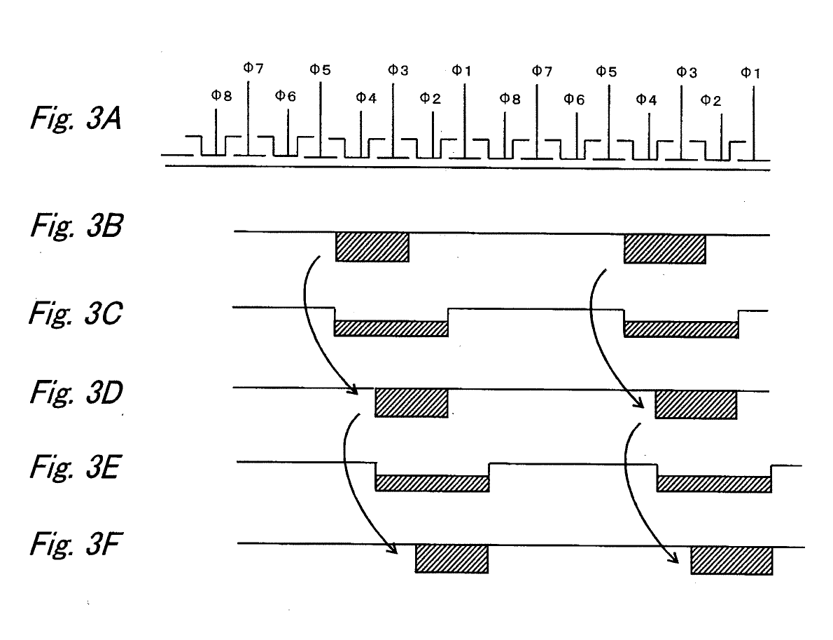

With reference to FIGS. 3A to 3F, the operation of vertical transfer of charges by the vertical transfer CCD 12 will be described below. Voltages Φ1 to Φ8 are applied to gates of each vertical transfer register 12a. In this example, transfer of the charges in the vertical transfer CCD 13 is controlled by application of voltage in eight-phase (eight-phase drive). The charges are transferred sequentially as shown sequentially in FIG. 3B to FIG. 3F. The gate which is applied voltage Φn (n=1 to 8) is referred to as “gate Φn”. As shown in FIG. 3B, the voltages are applied to the gates Φ3 and Φ4 to deepen the potentials at vertical transfer registers relating to the gates Φ3 and Φ4 to store the pixel data in the vertical transfer registers. In this situation, as shown in FIG. 3C, the voltage is applied to the gates Φ2 to deepen the potential at the vertical transfer registers relating to the gates Φ2 to Φ4. Then the voltage applied to the gate Φ4 is turned off to shallow the potentials at the vertical transfer register relating to the gate Φ4. Hence, the charges are stored in the vertical transfer registers relating to the gates Φ2 and Φ3 (see FIG. 3D). Similarly the charges are sequentially transferred by changing the voltages applied to the gates (see FIGS. 3E and 3F).

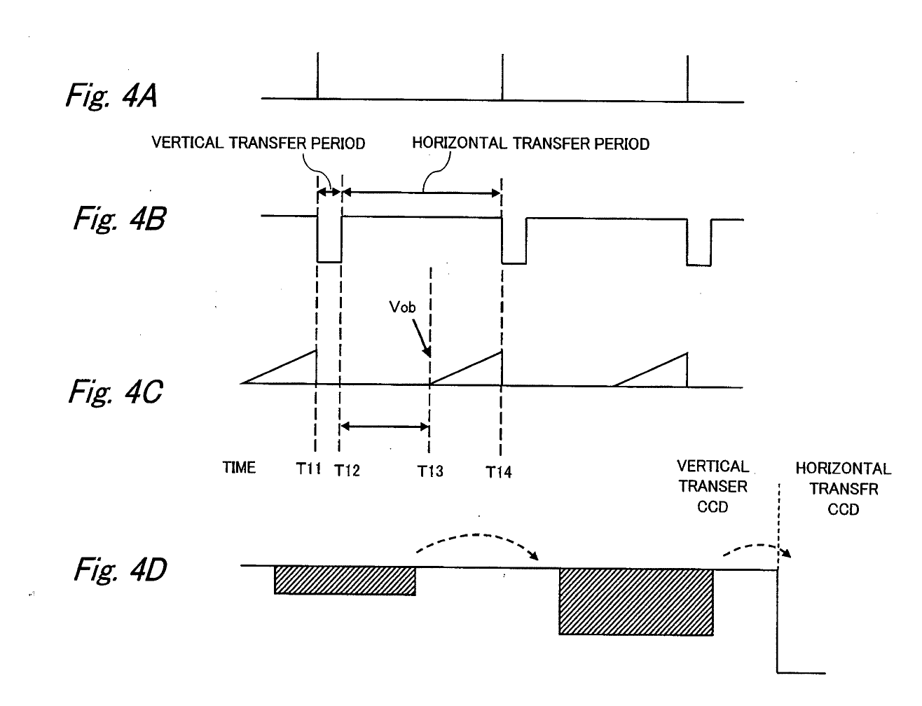

FIGS. 4A to 4D are timing charts showing driving timing of the CCD image sensor of the first embodiment.

FIG. 4A is a timing chart showing output timing of a horizontal synchronization signal (HD). The CCD image sensor outputs image data of one picture to an external in synchronization with a horizontal synchronization signal.

FIG. 4B is a timing chart showing a driving state of the horizontal transfer CCD 13. Referring to FIG. 4B, a “Hi” period is a period for which the horizontal transfer CCD 13 is driven. In this period, the pixel data is sequentially transferred to the output amplifier 14 through the horizontal transfer CCD 13. This period is referred to as a “horizontal transfer period”. On the other hand, a “Low” period is a period for which the vertical transfer CCD 12 is driven. In this period, the pixel data is sequentially transferred to the horizontal transfer CCD 13 through the vertical transfer CCD 12. The period is referred to as a “vertical transfer period”. It is also referred to as a “horizontal blanking period” because in this period the horizontal transfer CCD 13 is not driven.

FIG. 4C shows a change in amount of unnecessary charge overflowing from the vertical transfer register 12a to the horizontal transfer register 13a. When the unnecessary charge amount is increased, a noise is generated in the image data amplified by the output amplifier 14. The defect with the overflowing unnecessary charge will be described below.

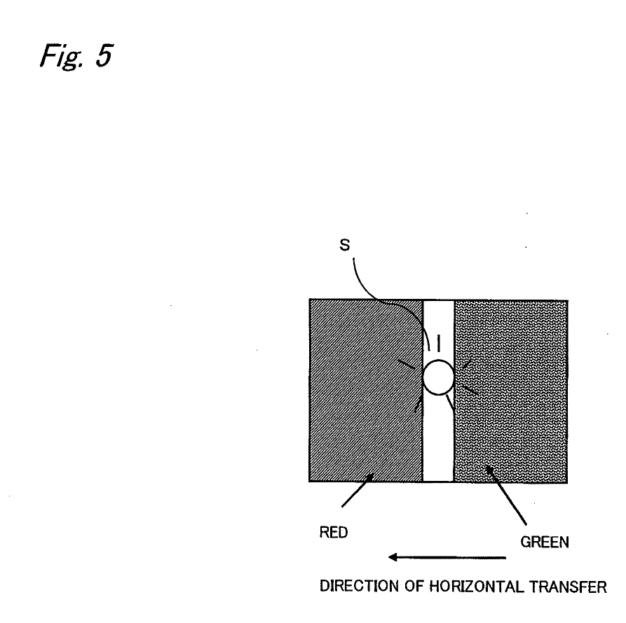

FIG. 5 shows an example of an image which is generated by image data supplied from the CCD image sensor when the high-brightness subject is imaged on the CCD image sensor. In cases where a high-brightness subject S is imaged on the CCD image sensor, the CCD image sensor could generate image data providing an image of which area on the left side of the subject S is red and area on the right side of the subject S is green as shown in FIG. 5. The reason will be described below.

A smear or blooming is generated on imaging a high-brightness subject such as the sun. Therefore, vertical transfer CCD 12 is filled with the charges, and the charges could overflow from the vertical transfer CCD 12 into the horizontal transfer CCD 13. FIG. 4D shows a state under that situation, of the charges stored in the vertical transfer register. As shown in FIG. 4C, it is assumed that Vob is the black level at the beginning of the overflow of the vertical transfer CCD 12. At this time, the horizontal transfer CCD 13 is operating, and thus the pixel data read from the OB unit 15 passes through the neighborhood of the high-brightness portion while the pixel data is being transferred in the horizontal transfer CCD 13. During it, in cases where the charges overflow from the vertical transfer CCD 12 into the horizontal transfer CCD 13, the charges overflowing from the vertical transfer CCD 12 are added to the charges generated by the OB unit 15. Originally the charges generated by the OB unit 15 are used to define the zero level. Therefore, the black level of the image fluctuates when the charges overflowing from the vertical transfer CCD 12 are added to the charges generated by the OB unit 15. A signal processing unit is connected to the downstream of the output amplifier 14, and sets the black level Vob to the zero level. Therefore, the black level is set at zero or less before the charges overflowing from the vertical transfer CCD 12 are added, and the black level is set at a level to which an additional signal is added after the charges overflowing from the vertical transfer CCD 12 are added. White balance is also corrected based on the signal level, and thus the image becomes green before the high-brightness portion while the image becomes red after the high-brightness portion, as shown in FIG. 5.

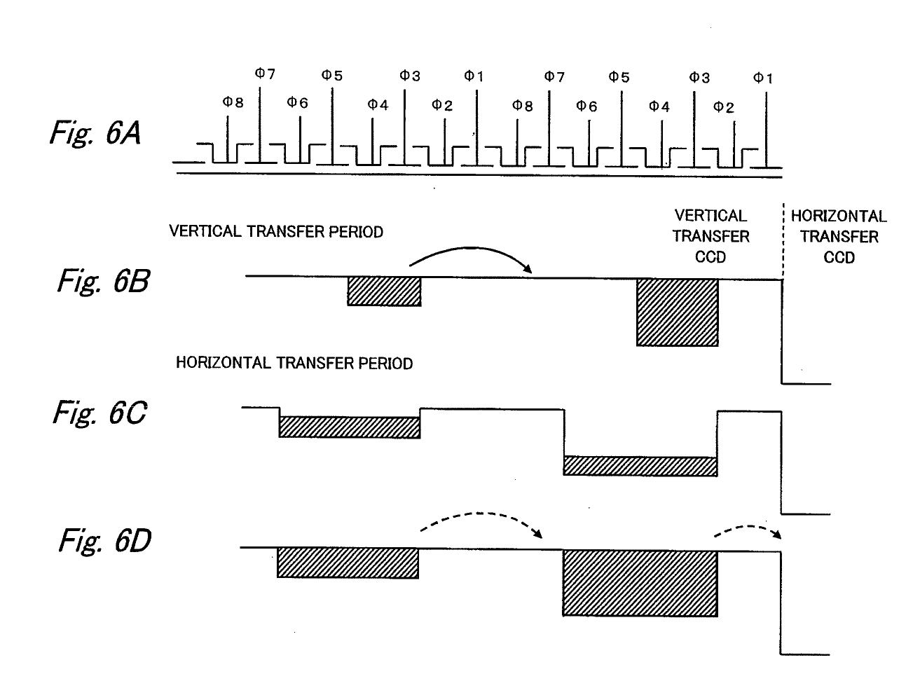

In order to solve the problem, in the first embodiment, the number of vertical transfer registers used for storing (retaining) the charges during the horizontal transfer period is set larger than the number of vertical transfer registers used for storing (retaining) the charges during the vertical transfer period. With this arrangement, a frequency and an amount of charges overflowing from the vertical transfer register into the horizontal transfer register can be decreased, so that the problem that the charges overflowing from the vertical transfer CCD 12 are added to the charges generated by the OB unit 15 can be reduced. This operation will be described in details with reference to FIGS. 4A to 4D and FIGS. 6A to 6D.

FIG. 6A shows a gate array of the transfer register 12a in the vertical transfer CCD 12. FIGS. 6B to 6D show storage state of the charges in the vertical transfer register 12a. The potential at the right end of FIGS. 6A to 6D shows the potential at the horizontal transfer CCD 13 (horizontal transfer registers 13a).

In this embodiment, during the vertical transfer period, the pixel data is sequentially transferred vertically while the pixel data generated by one photodiode is stored using two vertical transfer registers. Specifically, as shown in FIG. 6B, the respective voltages are applied to the two gates Φ3 and Φ4 to deepen the potentials at the vertical transfer registers relating to the gates Φ3 and Φ4 to store the pixel data in the vertical transfer registers.

On the other hand, during the horizontal transfer period, the pixel data is stored using four vertical transfer registers. As shown in FIG. 6C, the respective voltages are applied to the four gates Φ3 to Φ6 to deepen the potentials at the vertical transfer registers relating to the gates Φ3 to Φ6 to store the pixel data in the vertical transfer registers. During the horizontal transfer period, the vertical transfer registers does not operate and keeps the potentials shown in FIG. 6C.

For example, FIG. 6B corresponds to the state of the charges between the time T11 and the time T12 of FIG. 4C, that is, during the vertical transfer period. FIG. 6C corresponds to the state of the charges at the time T12 of FIG. 4C. Then, the charges are being gradually accumulated due to the blooming or smear, and subsequently the vertical transfer registers 12a becomes full with the charges as shown in FIG. 6D. FIG. 6D shows the state just before overflow, and corresponds to the state of the charges at the time T13 of FIG. 4C. According to this embodiment, the frequency of generation of the state shown in FIG. 6D can be decreased or the generation of the state shown in FIG. 6D can be delayed.

In FIGS. 6B, 6C, and 6D, the potentials at vertical transfer registers on the side near the horizontal transfer register are set deeper. This is for the charges being smoothly transferred from the vertical transfer register to the horizontal transfer register.

Thus, in this embodiment, the CCD image sensor is controlled such that the number of transfer registers for storing the charges during the horizontal transfer period is larger than that during the vertical transfer period.

With this arrangement, the capacity of the charge storing portion of the vertical transfer CCD 12, which is formed before the horizontal transfer CCD 13, can be increased. The charge storing portion disposed before the horizontal transfer CCD 13 acts as a dam which prevents the charges from overflowing from the vertical transfer CCD 12 to the horizontal transfer CCD 13. The increased capacity of the charge storing portion can lengthen a time from the start of the horizontal transfer period until the charges overflow from the vertical transfer CCD 12. That is, the interval from the time T12 to time T13 of FIG. 4C can be lengthened. Therefore, the time until the horizontal transfer period is ended since the charges overflow from the vertical transfer CCD 12 is shortened, so that the amount of charges overflowing into the horizontal transfer CCD 13 can be decreased. Accordingly, the amount of unnecessary charges added to the charges generated by the OB unit 15 can be decreased.

When the horizontal transfer period is ended (the “Hi” period is changed to the “Low” period) at the time T14 of FIG. 4B, the number of vertical transfer registers 12a is changed from four to two. That is, the state is changed from that shown in FIG. 6D to that shown in FIG. 6B. Accordingly, the excess charges of two transfer registers are generated, but the excess charges flow to a ground (p-type layer) of the photodiode 11. In the surroundings of the vertical transfer CCD 12, a p-type separation region exists between the vertical transfer CCD 12 and the photodiode 11 and thus the excess charges flow into the separation region.

In this embodiment, the charges are stored in the vertical transfer registers relating to the gates Φ3 and Φ4 or in the vertical transfer registers relating to the gates Φ3 to Φ6. Alternatively, the charges may be stored in the vertical transfer registers relating to the gates Φ1 and Φ2 or in the vertical transfer registers relating to the gates Φ1 to Φ4. Alternatively, the charges may be stored in the vertical transfer registers relating to the gates Φ1 to Φ6. In this embodiment, the vertical transfer CCD 12 is driven in the eight-phase drive by way of example. However, the number of driving gates is not limited to eight. For example, the concept of this embodiment can also be applied to six-phase or twelve-phase drive.

For only vertical transfer registers relating to the charge storing portion disposed just before the horizontal transfer CCD 13, the number of the vertical transfer registers used for storing the charges during the horizontal transfer period may be larger than that during the vertical transfer period.

### Second Embodiment

In the first embodiment, there is an operation changing the number of transfer registers which stores the charges from four to two, and thus the charges may easily flow into the ground (p-type layer) of the photodiode 11. The resistance of the ground (p-type layer) of the CCD image sensor is high, and thus the ground voltage can be changed depending on amount of the charges flowing into the ground. This causes a phenomenon in which the charges leak from the photodiode 11 to the vertical transfer CCD 12 without a reading operation. The phenomenon is referred to as “blooming”. In the second embodiment, a configuration of a CCD image sensor which can restrain the generation of the blooming will be described.

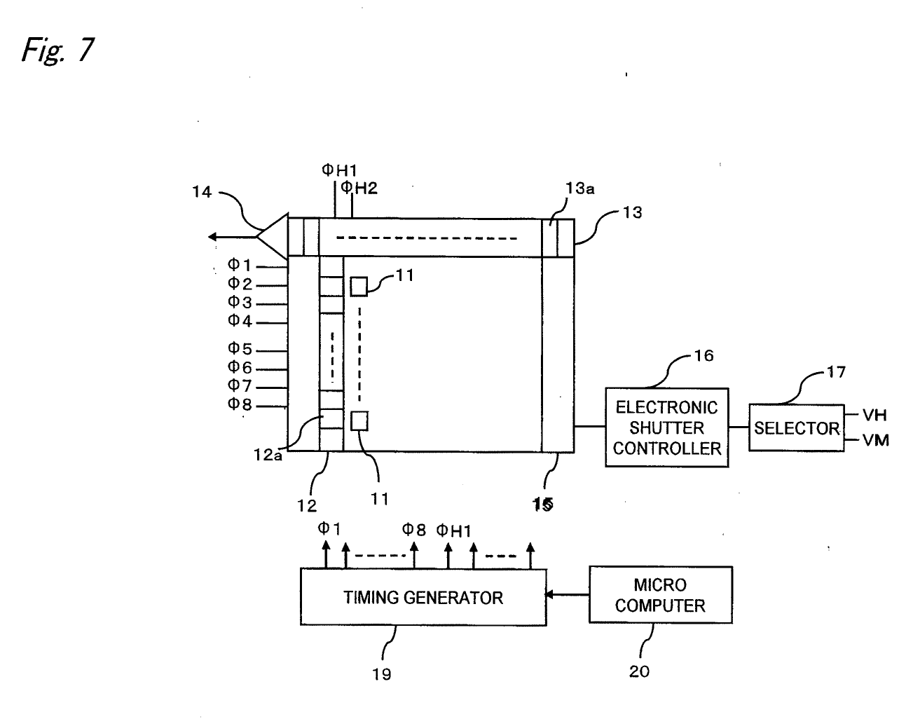

FIG. 7 shows the configuration of the CCD image sensor of the second embodiment. The CCD image sensor of the second embodiment includes a selector 17 in addition to the configuration of FIG. 1. The selector 17 selects one of two kinds of voltages VH and VM as a voltage applied to the substrate, and supplies the selected voltage to the electronic shutter controller 16. The selector 17 performs the selecting operation based on a control signal supplied from the timing generator 19. The voltage VH or VM can be applied as the substrate voltage by the selector 17 and the electronic shutter controller 16. The voltage VH is a higher voltage applied in activating the usual electronic shutter function, and the voltage VM is a lower voltage than the voltage VH.

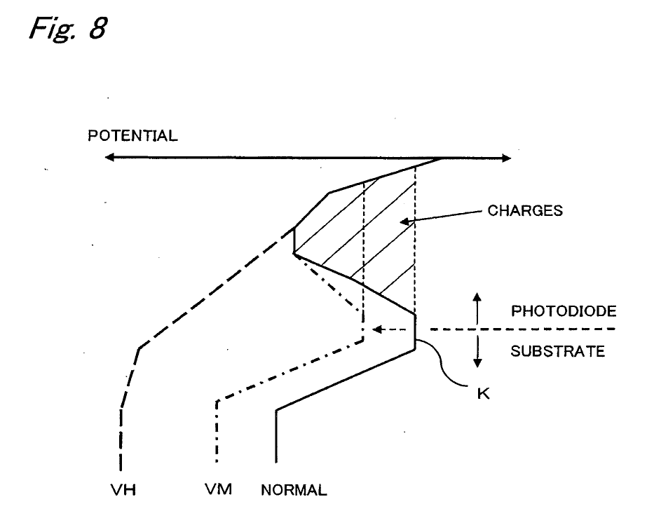

FIG. 8 is a potential sectional view showing a potential near a boundary between the photodiode 11 and the substrate. In FIG. 8, the solid line indicates the potential for the case in which the electronic shutter function is not activated (hereinafter referred to as a “normal state”). The broken line indicates the potential for the case in which the electronic shutter function is activated, with the voltage VH applied as the substrate voltage. The dashed line indicates the potential with the voltage VM which is lower than the voltage VH applied as the substrate voltage.

In the normal state, as shown in the solid line of FIG. 8, a maximum portion K of the potential is formed between a surface of photodiode 11 and the substrate. The maximum portion K forms a valley portion of the potential, which can store the charges.

When the voltage VH is applied as the substrate voltage, as shown by the broken line of FIG. 8, the maximum portion K is eliminated and thus the valley portion is eliminated. Therefore, the charges generated by the photodiode 11 are discharged to the side of the substrate of the CCD image sensor.

Value of the potential at the maximum portion K can be controlled by appropriately adjusting the substrate voltage by the electronic shutter controller 16. In the second embodiment, the maximum portion K is made smaller than that in the normal state by applying the voltage VM lower than the voltage VH as the substrate voltage. When the voltage VM is applied, as shown with the dashed line in FIG. 8, the maximum portion K is smaller, and the formed valley portion becomes shallow, thereby decreasing the capacity for storing the charges in the valley portion. Therefore, when the charge amount is increased in the valley portion, the charges pass on the side of the substrate of the CCD image sensor before the charges overflow from the photodiode 11 on the surface of the CCD image sensor.

The selector 17 switches the voltage supplied to the electronic shutter controller 16 to one of the voltage VH and the voltage VM. When the selector 17 selects the higher voltage VH to apply the voltage VH as the substrate voltage, all the charges in the photodiode 11 are discharged to the substrate side.

The blooming may be hardly generated when the capacity of the photodiode 11 is decreased. However, regarding the general electronic shutter, the voltage is applied only for a short time but cannot always be applied due to the circuit configuration.

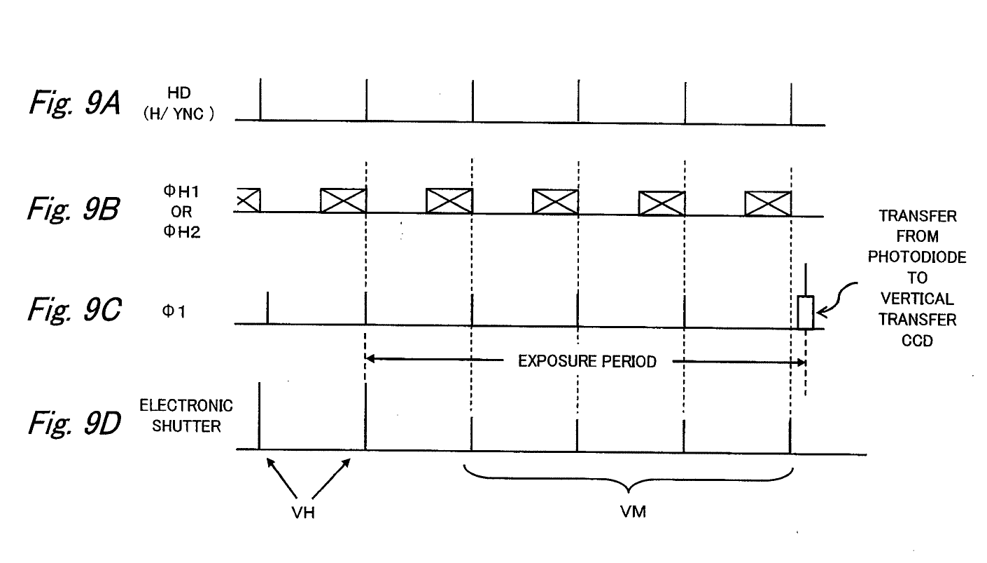

Therefore, in the second embodiment, the voltage VM is applied once every horizontal transfer period (HD) as shown in FIG. 9D. The normal electronic shutter (application of the voltage VH) is operated before an exposure, and an exposure operation stars after all the charges are discharged. Then, the voltage VM is applied once every horizontal transfer period during the exposure period.

Specifically, during the exposure period, the timing generator 19 receives information indicating the exposure period from the microcomputer 20, and outputs the control signal for realizing the operation shown in FIG. 9D to the electronic shutter controller 16 and the selector 17. Then, the selector 17 selects the voltage VM, and the electronic shutter controller 16 applies the voltage VM once every horizontal transfer period (HD).

As described above, during the exposure period, applying the voltage VM as the substrate voltage once every horizontal transfer period (HD) can reduce the capacity of the photodiode 11. With this, the blooming is hardly generated even if the charges of the photodiode 11 flow into the p-type layer of the substrate, so that the defect of the image can be reduced when imaging the high-brightness subject.

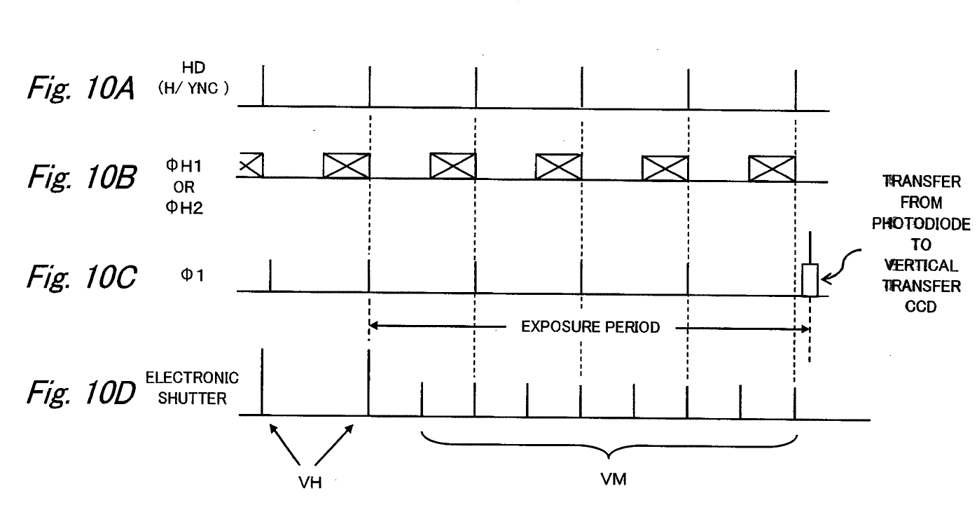

FIGS. 10A to 10D show different timing charts. In the timing charts of FIGS. 9A to 9D, the voltage VM is applied once every horizontal transfer period. On the other hand, in the timing charts of FIGS. 10A to 10D, the voltage VM is applied twice every horizontal transfer period. Therefore, the amount of charges stored in the photodiode 11 is further decreased, and the generation of the blooming is further restrained, so that the defect of the image can further be reduced in imaging the high-brightness subject. The voltage VM may be applied at N (N is an integer more than 2) times every horizontal transfer period.

### INDUSTRIAL APPLICABILITY

According to the present invention, the image having good quality can be supplied even in imaging the high-brightness subject, and therefore the present invention is useful to an imaging device which can be mounted on a digital still camera, movie camera, a camera-equipped portable telephone terminal, and the like.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2008-028823, filed on Feb. 8, 2008, which is expressly incorporated herein by reference in its entirety.

What is claimed is:

1. An imaging device comprising:
photoelectric conversion elements operable to generate charges as pixel data by photoelectric conversion;
a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period;
a horizontal transfer unit operable to horizontally transfer the charges transferred by the vertical transfer unit during a horizontal transfer period; and
a controller operable to control the vertical transfer unit and the horizontal transfer unit,
wherein the controller controls the vertical transfer unit such that the number of transfer registers used to store the charges during the horizontal transfer period is larger than the number of transfer registers used to store the charges during the vertical transfer period.

2. A driving method of an imaging device, wherein
the imaging device comprises
photoelectric conversion elements operable to generate charges as pixel data by photoelectric conversion,
a vertical transfer unit including a plurality of transfer registers which can store the charges generated by the photoelectric conversion elements and are disposed in a vertical direction, and being operable to sequentially transfer the charges in the vertical direction by sequentially switching the transfer registers during a vertical transfer period, and
a horizontal transfer unit operable to horizontally transfer the charges transferred by the vertical transfer unit during a horizontal transfer period, and
the driving method comprises controlling the number of transfer registers such that the number of transfer registers used to store the charges during the horizontal transfer period is larger than the number of transfer registers used to store the charges during the vertical transfer period.

3. An imaging device comprising:
photoelectric conversion elements formed on a substrate to generate charges as pixel data by photoelectric conversion;
a vertical transfer unit including a plurality of transfer registers which can store the charges generated by the photoelectric conversion elements and are disposed a the vertical direction, and being operable to sequentially transfer the charges in the vertical direction by sequentially switching the transfer registers during a vertical transfer period;
a horizontal transfer unit operable to horizontally transfer the charges transferred by the vertical transfer unit during a horizontal transfer period; and
an electronic shutter controller operable to control an electronic shutter function of discharging the charges generated by the photoelectric conversion element to the substrate side,
wherein the electronic shutter controller is operable to control applying a first voltage which is applied for performing the electronic shutter function and a second voltage which is lower than the first voltage, to the substrate, and applies the second voltage a predetermined times per horizontal transfer period during an exposure period of the photoelectric conversion element.

4. The imaging device according to claim 3, wherein the predetermined times is once or twice.

5. A driving method of an imaging device, wherein
the imaging device comprises:
photoelectric conversion elements formed on a substrate to generate charges as pixel data by photoelectric conversion;
a vertical transfer unit including a plurality of transfer registers which can store the charges generated by the photoelectric conversion elements and are disposed at the vertical direction, and being operable to sequentially transfer the charges in the vertical direction by sequentially switching the transfer registers during a vertical transfer period;
a horizontal transfer unit operable to horizontally transfer the charges transferred by the vertical transfer unit during a horizontal transfer period; and
an electronic shutter controller operable to control an electronic shutter function of discharging the charges generated by the photoelectric conversion element to the substrate side, and
the driving method comprises:
applying a first voltage to the substrate when performing the electronic shutter function, and
applying a second voltage which is lower than the first voltage to the substrate, a predetermined times per horizontal transfer period during an exposure period of the photoelectric conversion element.

6. The driving method according to claim 5, wherein the predetermined times is once or twice.
